(19) United States
(12) Patent Application Publication
(10) Pub. No.: US 2026/0315307 A1
(43) Pub. Date: Oct. 15, 2026

(54) FOLDABLE STANDING-BASE MECHANISM

(71) Applicants: STEETS GMBH, Paderborn (DE); ROLLAX GMBH & CO. KG, Bad Salzuflen (DE)

(72) Inventors: Thorben ENGEL, Kõln (DE); Tatjana Korent, Steinhagen (DE); Bernd Zimmerbeutel, Remscheid (DE); Phil Janssen, Kõln (DE); Philipp Battisti, Paderborn (DE)

(21) Appl. No.: 19/491,504

(22) PCT Filed: Jun. 5, 2024
(86) PCT No.: PCT/EP2024/065472

§ 371 Date: Dec. 9, 2025

(30) Foreign Application Priority Data
Jun. 21, 2023 (DE) 20 2023 103 423.3

(51) Int. Cl. A61H 3/02

(52) U.S. Cl. CPC A61H 3/0244; A61H 2003/0272; A61H 2201/1635; A61H 2201/5025

(57) ABSTRACT

A standing-base device for objects (12) that can be set up upright, with a support module (10) to be attached to the lower end of the object (12), the support module having a plurality of support legs (26) arranged in a star shape, which can be pivoted between a support position and a raised rest position, and with an actuating device (14) to be attached further up on the object for transferring the support legs (26) from the rest position to the support position, wherein the support legs (26) are elastically biased into the rest position and, when they have been moved into the support position by the actuating device (14), are held in the support position by a detent device (52), and that the detent device (52) is designed to yield under overload and release the support legs.

The invention relates to a standing-base device for objects that can be set up upright, with a support module to be attached to the lower end of the object, said support module having several support legs that are arranged in a star shape and can be pivoted between a support position and a folded-up rest position, and with an actuating device to be attached further up on the object for transferring the support legs from the rest position to the support position.

The object to be set up may be, for example, a walking stick or a crutch. A crutch with a standing base device of the above-mentioned type is known from DE 20 2016 006 179 U1.

The object of the invention is to create a standing base device that is easier to handle.

According to the invention, this object is achieved by the support legs being elastically biased into the rest position and, when they have been moved into the support position by means of the actuating device, being held in the support position by a locking device, and by the locking device being designed to yield under overload and release the support legs.

According to the invention, the actuating device is only needed to move the support legs from the rest position to the support position, while the reverse process, i.e., moving the support legs from the support position to the rest position, is triggered by the user applying a downward force to the object. In addition to the weight of the object, the support legs are then subjected to the additional force exerted by hand, which causes the locking mechanism to yield and release the support legs, allowing them to return automatically to the rest position due to the elastic preload.

This solution has the advantage that, when the user wants to retract the support legs, they do not have to operate the actuating device again, but only need to exert slightly more pressure on the object (walking stick or crutch). Another advantage is that the mechanical connection between the actuating device and the support module can be formed by a simple pull cord, since the force only needs to be transmitted in one direction. If the crutch is height-adjustable, this also has the advantage that the length of the pull cord can be easily adjusted to the respective length of the crutch by winding an unused section of the pull cord onto a spool.

An embodiment example will now be described in more detail with reference to the drawings, wherein:

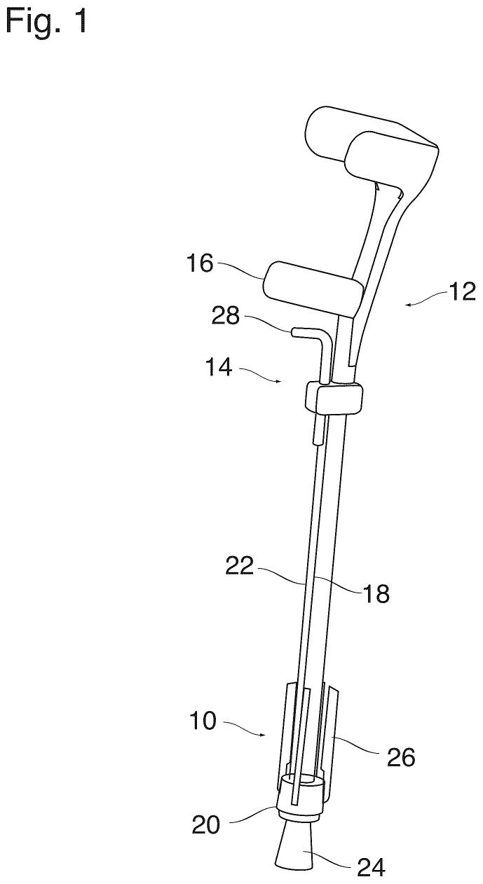

FIG. 1 shows the standing-base device according to the invention in a rest position;

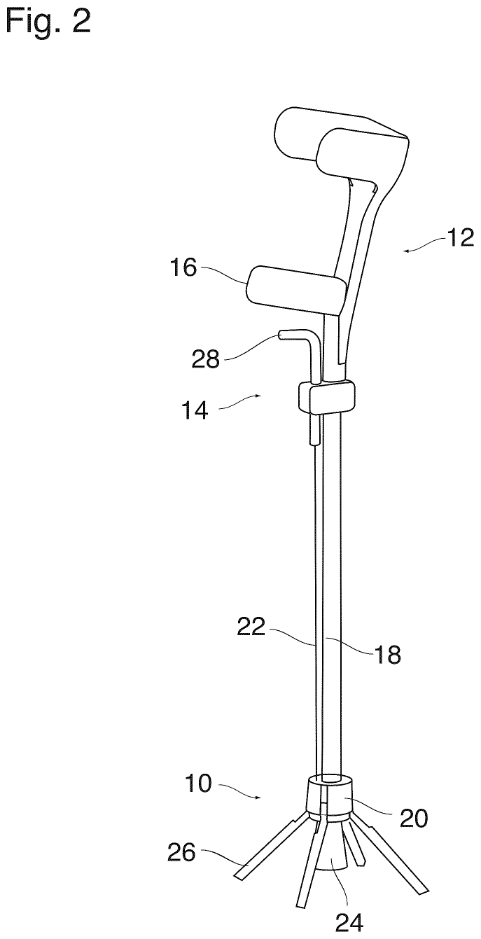

FIG. 2 shows the standing-base device in a support position;

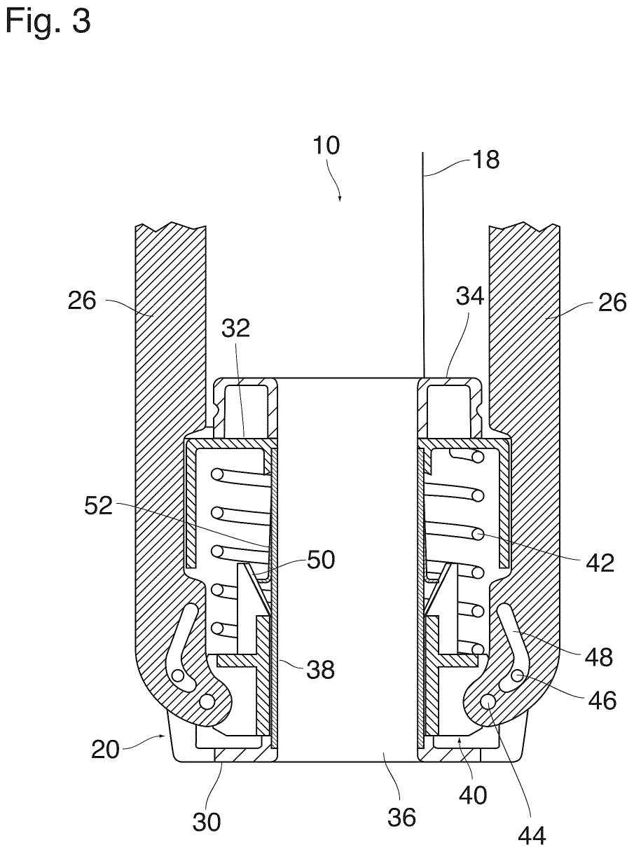

FIG. 3 is a section through a support module, which forms an essential part of the standing-base device, in a rest position;

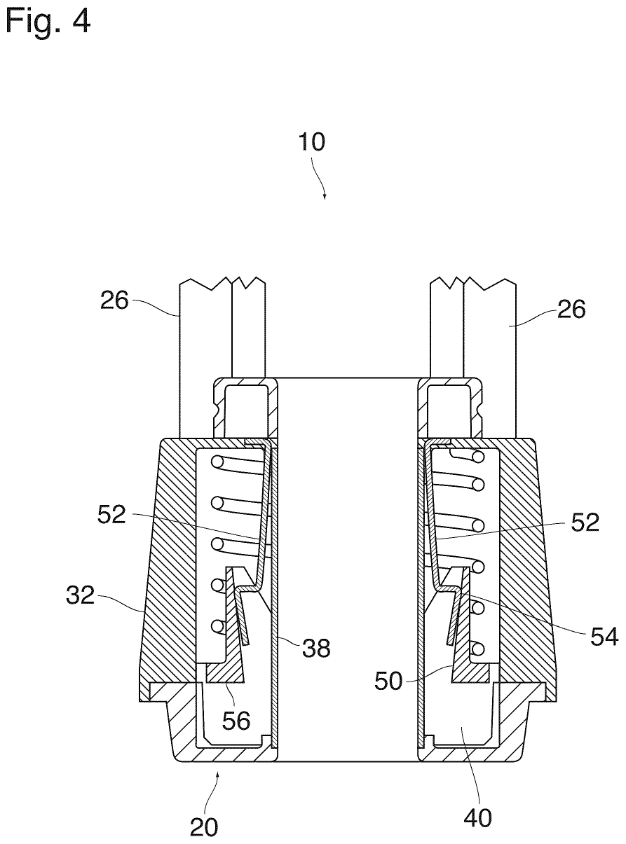

FIG. 4 is a section through the support module in a sectional plane rotated relative to FIG. 3;

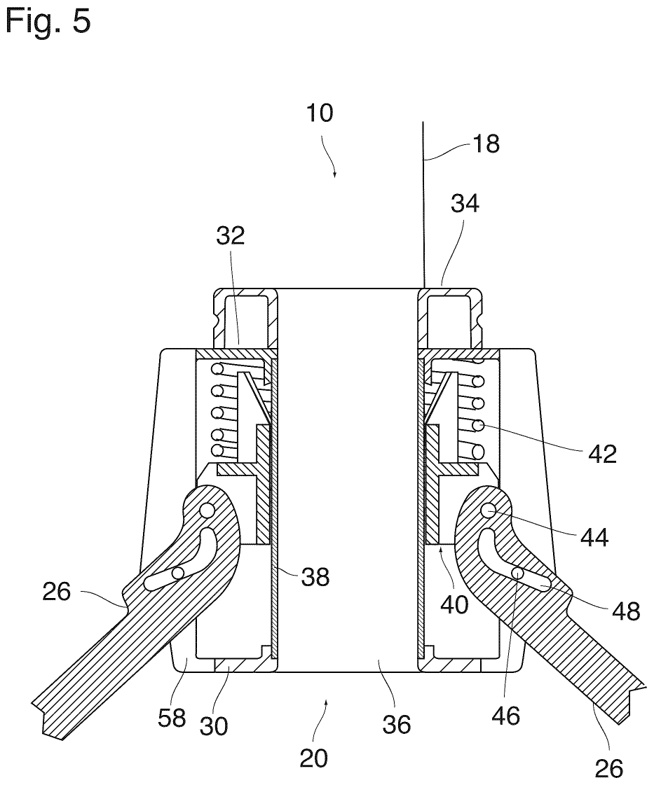

FIG. 5 is a section in the same sectional plane as in FIG. 3, but for a support position of the support module;

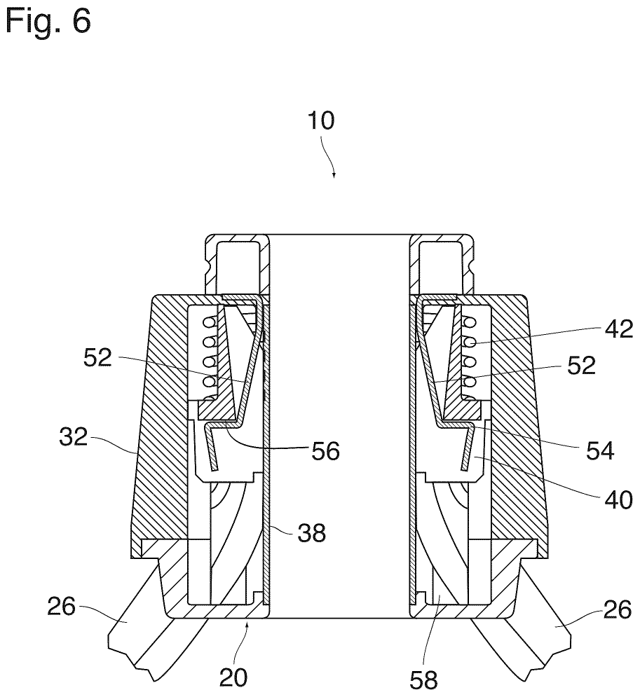

FIG. 6 is a section through the support module in the support position, in the same sectional plane as in FIG. 4; and

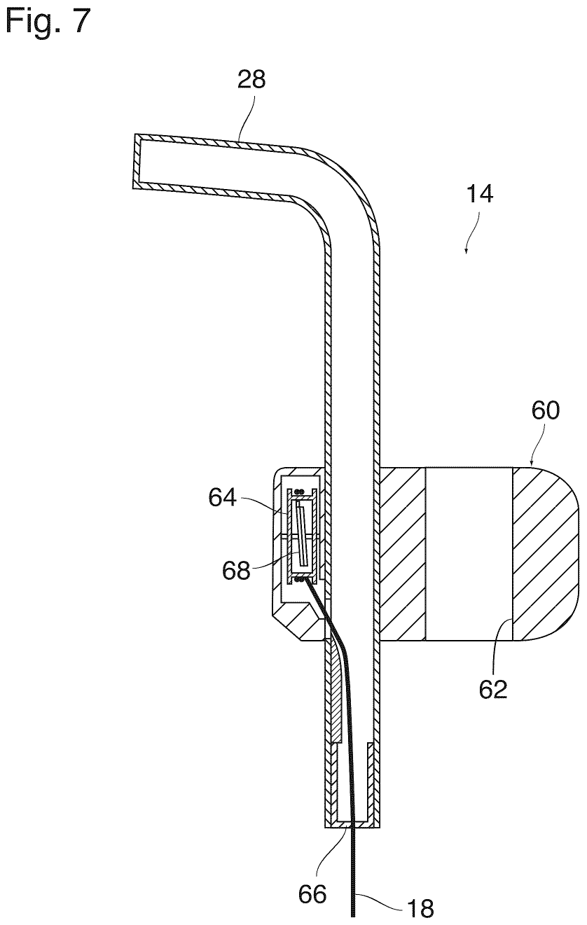

FIG. 7 is a section through an actuating device belonging to the standing-base device.

The standing-base device shown in FIG. 1 has a support module 10 that is attached to the lower end of an object 12 to be set up. In this example, the object to be set up is a forearm crutch. The standing-base device also includes an actuating device 14, which is attached to the object 12 in a slightly higher position below a handle 16 of the crutch and is connected to the support module 10 via a pull cord 18.

The support module 10 has a housing 20 that is rigidly attached to the lower end of a tube 22 of the crutch. A rubber buffer 24 attached to the lower end of the tube 22 protrudes downward from the housing 20. Four support legs 26 are pivotably mounted in the housing 20. The bearing points of the support legs 26 are distributed at equal angular intervals around the circumference of the housing 20. FIG. 1 shows the support legs 26 in a rest position in which they are folded up against the tube 22. In this position, the user can use the crutch normally as a walking aid without the standing-base device getting in the way.

The actuating device 14 has a handle 28 that is guided vertically on the tube 22 of the crutch. When the user wishes to set down the object 12, he pulls the handle 28 upward with his hand, thereby exerting tension on the pull cord 18. This causes the support legs 26 to move into the support position shown in FIG. 2, in which they protrude from the housing 20 in a star shape and extend diagonally downward toward the ground. This holds the crutch stably in a vertical position in which the rubber buffer 24 is slightly above the ground, so that the weight of the crutch is supported solely by the four support legs 26.

FIG. 3 shows an axial section through the housing 20 and through two of the four support legs 26, which are in the rest position as shown in FIG. 1.

The housing 20 has a base part 30, an upper part 32, and a fastening ring 34 for fastening the housing 20 to the tube 22 of the crutch, which is not shown in FIG. 3. When the support module 10 is attached to the tube of the crutch, the tube 22 runs through a channel 36 formed in the housing 20. The lower part of the channel 36 is formed by a cylindrical sleeve 38 on which an anchor 40 is guided so that it can move vertically. A spring 42 is supported on the upper wall of the upper part 32 and elastically biases the anchor 40 downward. Four bearing pins 44 are held in the lower part of the anchor 40, each forming a pivot bearing for one of the support legs 26. Four retaining pins 46 are held in the base part 30 of the housing 20 so that they each extend through a guide slot 48 formed in one of the support legs 26. In the state shown in FIG. 3, the bearing pins 44 are pressed downwards by the spring 42, so that they tend to pull the support legs 26 downwards. In doing so, the retaining pins 46 each slide onto a wall of the associated guide slot 48 and exert an upward force on the support leg. Due to a radial offset between the bearing pins 44 and the retaining pins 46, a torque is generated which tends to hold the support leg in the rest position, in which it is folded against the crutch tube.

The pull cord 18 is connected to the anchor 40 inside the housing 20. When the user pulls on the pull cord 18, the anchor 40 is pulled upward against the force of the spring 42. Accordingly, the support legs 26 also tend to move upward, with one wall of their guide slot 48 running onto the retaining pin 46. This reverses the force couple formed at the bearing pins 44 and retaining pins 46, creating a torque that tends to swing the support legs 26 outward.

A part of the anchor 40 located within the spring 42 forms an inner cone 50, against which spring arms, only partially visible in FIG. 3, of detent devices 52 bear.

In FIG. 4, the sectional plane is rotated such that the detent members 52 are more clearly visible. The detent devices are held rigidly in the upper wall of the upper part 32 with their upper ends, and their spring arms are spread downward from the sleeve 38. At the lower end, each spring arm forms a horizontal shoulder and a knee 54 that rests against the inner surface of the cone 50. When the anchor 40 is pulled upward, the detent devices 52 are deflected elastically inward so that their spring arms pivot against the sleeve 38. The cone 50 of the anchor 40 merges into a horizontal support wall 56 at the lower end. When the anchor 40 is pulled further upward and the underside of the support wall 56 reaches the height of the knee 54, the detent devices 52 spring back to their initial position so that their horizontal shoulders rest against the underside of the support wall 56, as shown in FIG. 6. In this way, the anchor 40 is locked in the raised position.

In a cross-section corresponding to FIG. 3, FIG. 5 shows the support module in the support position. The anchor 40 is locked in the raised position and has compressed the spring 42. By raising the axle pins 44 while leaving the retaining pins 46 unchanged, the support legs 26 were swiveled downwards. The guide slots 48 allow compensation for the changes in length that result from the axle pins 44 moving only vertically and retaining their radial position. The weight of the crutch presses the upper ends of the support legs 26 against the ground, and a torque is created in each case which tends to pivot the support leg around the retaining pin 46 and pull the bearing pin 44 and thus the anchor 40 downwards, which is however prevented by the locking of the anchor 40. In FIG. 6, the support legs 26 can also be seen in the support position. The upper ends of the support legs enter the interior of the housing 20 through openings 58, where they are mounted on the bearing pins 44 of the anchor 40.

When the support legs 26 are to be returned to their rest position, the user presses down on the crutch with their hand, thereby increasing the torque acting on the support legs 26. The support wall 56 of the anchor then exerts a downward force on the horizontal shoulders of the detent devices 52, while the radially inner ends of the detent devices remain fixed to the upper part 32 of the housing. This creates a bending moment that tends to swing the detent devices back against the sleeve 38. The knees 54 of the detent devices move radially inward. When the force is large enough, the knees 54 pass the inner edge of the support wall 56, and the anchor 40 slips off the horizontal shoulders of the detent devices 52 and moves down again under the force of the spring 42. In the process, the support legs 26 are swung back to their rest position.

FIG. 7 shows a cross-sectional view of the actuating device 14. The handle 28 is formed by an L-shaped bent tube, the longer vertical leg of which is guided in a sliding manner in a clamp 60 that is rigidly mounted on the tube 22 of the walking aid. FIG. 7 shows a vertical shaft 62 of the clamp through which the tube 22 passes when the clamp is mounted.

A spool 64 is housed in a chamber inside the clamp 60, onto which an upper end section of the pull cord 18 is wound. The pull cord drawn-out from the spool 64 enters the interior of the tubular handle through an opening and exits the handle at the lower end. At the exit point, the pull cord is clamped by means of a clamping body 66. When the handle 28 is pulled upward, a pull is therefore exerted on the pull cord 18 to pull the anchor 40 of the support module 10 upward. Since the anchor is then held in the raised position by the detent devices 52, a slack forms in the section of the pull cord between the clamping body 66 and the spool 64. However, the spool 64 is preloaded in the direction of rotation by a spring 68 so that the pull rope is wound up and the slack is eliminated. The tension exerted by the spring 68 on the pull rope 18 holds the handle 28 in the raised position. Only when the user presses the handle 16 of the crutch with their hand (FIG. 1), thereby exerting a torque on the support legs 26 that is large enough to release the locking mechanism, does the anchor 40, under the action of the spring 42, pull the pull cord 18 and thus also the handle 28 back down, whereby the pull cord is pulled off the spool 64 against the force of the spring 68 until the initial position shown in FIG. 1 is reached again.

If the object 12 is an object with adjustable length, the length of the pull rope 18 can be easily adjusted to the changed length of the object by temporarily loosening the clamp on the clamping body 66 so that the spool 64 can compensate for the length difference.

What is claimed is:

1. A standing-base device for objects that can be set up upright, comprising:
a support module to be attached to the lower end of the object, said support module having a plurality of support legs arranged in a star shape, which are adapted to be pivoted between a lowered support position and a raised rest position,
an actuating device to be attached further up on the object for transferring the support legs from the rest position to the support position,
wherein the support legs are elastically biased into the rest position and
a detent device for holding the support legs in the support position when the support legs have been moved into the support position by the actuating device, and the detent device is configured to yield under overload and release the support legs.

2. The standing base device according to claim 1, wherein the support module comprises:
a housing,
an anchor movable vertically in the housing and connected to the actuating device,
wherein each support leg is mounted on a bearing pin fixed relative to the anchor and on a retaining pin fixed relative to the housing, and
wherein the bearing pin and the associated retaining pin are offset from each other in a radial direction and at least one of them is accommodated in a guide slot of the support leg.

3. The standing-base device according to claim 2,
further comprising a spring which elastically biases the anchor,
wherein the anchor is adapted to be pulled into a raised position by the actuating device, and
wherein the anchor has a contour that runs at an angle to the vertical, which causes an elastic deflection of the detent device when the anchor is pulled up until it engages with a support wall of the anchor.

4. The standing-base device according to claim 3, wherein the detent device has a spring arm which is anchored at an upper end thereof to the housing and extends radially outward and downward, and has a shoulder at a lower end thereof which, depending on the vertical position of the anchor, rests against the contour of the anchor or snaps-in at the support wall.

5. The standing-base device according to claim 4, wherein a plurality of said detent devices are distributed around the circumference of the housing.

6. The standing-base device according to claim 2, further comprising a pull cord for connecting the actuating device to the support module.

7. The standing-base device according to claim 6, wherein the pull cord engages with the anchor.

8. The standing-base device according to claim 7, wherein the actuating device comprises a clamp adapted to be attached to the object, and a handle that is guided axially movably in the clamp and is connected to the pull cord.

9. The standing base device according to claim 8, wherein the handle comprises a leg extending vertically through the clamp, the leg having a clamping body at its lower end for clamping the pull cord, and wherein the clamp carries a spring-loaded spool onto which an upper end section of the pull cord is adapted to be wound.
